(19) United States
(12) Patent Application Publication
(10) Pub. No.: US 2024/0275118 A1
(43) Pub. Date: Aug. 15, 2024

(54) Single Pass Optical Amplifer

(71) Applicant: Metrohm Spectro, Inc., Plainsboro, NJ (US)

(72) Inventors: Meg Mahat, Lawrenceville, NJ (US); Greg W. Charache, East Windsor, NJ (US)

(21) Appl. No.: 18/109,661

(22) Filed: Feb. 14, 2023

(51) Int. Cl. H01S 3/067; H01S 3/094; H01S 3/16

(52) U.S. Cl. CPC H01S 3/06758; H01S 3/094003; H01S 3/1603

(57) ABSTRACT

A narrow-linewidth, single-spatial-mode single-pass fiber-amplifier based light source is described that provides high-efficiency and high reliability. The major components of the design include: a narrow-linewidth single-spatial-mode semiconductor seed laser, a seed-laser PM optical isolator, a multimode semiconductor pump laser, a fiber-based PM combiner, an active gain fiber, and a frequency doubling crystal. The design is particularly suited for use as a high-power light source for numerous scientific and engineering applications, including: a Raman spectroscopic imaging microscope system and atomic clocks/atomic trapping and cooling.

### FIELD OF THE INVENTION

This invention relates to the field of high-efficiency, single-pass fiber-based amplifiers and more particularly that can be utilized for scientific and engineering applications, including a Raman spectroscopic imaging microscope system and atomic clocks/atomic trapping and cooling.

### BACKGROUND OF THE INVENTION

Raman spectroscopy is a well-known technique that can be used to observe vibrational, rotational, and other low-frequency modes in molecules. Raman scattering is an inelastic process whereby monochromatic light, typically provided by a laser, interacts with molecular vibrations, phonons, or other excitations, resulting in the energy of the laser photons being shifted up or down. Due to conservation of energy the emitted photon gains, or loses, energy equal to an energy of the vibrational state.

Raman imaging microscopy is differentiated from probe-based Raman spectroscopy in that the imaging spot size is designed to be focused to very small areas to allow for high-spatial-resolution imaging. It is common for these systems to require focused spot sizes of a few microns or less. Therefore, it is essential to have a high-efficiency single-spatial-mode laser with a nearly diffraction-limited beam quality (e.g., M² less than 1.1). In addition, a very narrow spectral linewidth (e.g., significantly less than 0.01 nanometer (nm)) is also required to obtain the required Raman spectral resolution. In order to produce a compact system, it is desired to utilize components with high electro-optical conversion efficiency that include single-spatial-mode semiconductor lasers. These semiconductor devices are often realized using distributed feedback (DFB) lasers (see for example, M. Maiwald, G. Erbert, A. Klehr, B. Sumpf, H. Wenzel, T. Laurent, J. Wiedmann, H. D. Kronfeldt, and H. Schmidt, “Reliable operation of 785 nm DFB diode lasers for rapid Raman spectroscopy,” Proc. SPIE 6456, 64560 W (2007)), distributed Bragg reflecting (DBR) lasers (see for example, U.S. Pat. Nos. 9,660,417 and 10,084,2840), or Fabry-Perot (FP) lasers utilized in conjunction with volume Bragg gratings (VBGs) (see for example, U.S. Pat. Nos. 9,287,681, 9,577,409, and 10,090,642).

However, these semiconductor lasers often suffer from catastrophic optical mirror damage if the optical output power level is increased above a few hundred milliwatts. For example, a commonly utilized fiber-coupled single-spatial-mode semiconductor laser for Raman microscopy at 785 nm emission wavelength is limited to less than 100 milliwatts (mW). Higher output power is desired to allow for faster scanning speeds when producing two-dimensional (2D) or three-dimensional (3D) Raman images of samples (see for example, G. Turrell and J. Corset, Eds., “Raman Microscopy, Developments and Applications,” Elsevier Ltd., San Diego (1996)).

Similarly, atomic clocks and atomic trapping/cooling applications require robust, compact, high-efficiency, narrow linewidth single-spatial-mode lasers for the formation of the optical lattice required to trap the ultra-cold atoms long enough for ultra-high-resolution measurements of the clock transition [see for example, C. W. Oates and A. D. Ludlow, “Optical Lattice Clocks,” Optics and Photonics News, pp 37-43 (January 2015), and A. Mugnier, M. Jacquement, E. LeMercier, R. Lebref, and D. Pureur, “High power single-frequency 780-nm fiber laser source for Rb trapping and cooling applications,” Proc. SPIE 8237, 82371F (2012)). These high-power lasers in the 1-10 W level far exceeds what can be achieved with single-mode semiconductor lasers.

One method utilized to increase the power of semiconductor lasers sources is a master oscillator power amplifier (see for example, L. Ogrodwoski, P. Friedmann, J. Gilly, and M. Kelemen, “Tapered amplifiers for high-power MOPA setups between 750 nm and 2000 nm,” Proc. SPIE 11301, 113011E (2020)). In this configuration, a lower-power semiconductor seed laser is amplified with a separate semiconductor-based optical amplifier that in principle has higher output power in the 500 mW-10 W range. However, these semiconductor amplifiers suffer from asymmetrical output beams, movement of the single-spatial-mode over time, and poor lifetime.

In addition, the fiber amplifiers that have been presented in the literature are often low-efficiency and consist of a mix of free-space and fiber coupled components.

Hence, there is a need in the industry for a reliable and compact high-efficiency narrow-linewidth, single-spatial-mode laser source that provides higher output power for various scientific and engineering applications that include Raman imaging, atomic clocks, and atomic trapping/cooling.

### SUMMARY OF THE INVENTION

The single-pass fiber-laser-based light source described, herein, utilizes a fiber-coupled narrow-linewidth semiconductor seed laser having an output that is amplified by a fiber-based gain medium selected based on the wavelength of the seed laser. The fiber-based gain medium is inherently single-spatial-mode and offers much higher mode-stability and reliability that a semiconductor-based gain medium described previously.

In one aspect of the invention, the output of the fiber-based gain medium is frequency-doubled using a high efficiency single-pass periodically poled magnesium-oxide-doped lithium niobate (PPMgO:LN) waveguide to obtain a desired output wavelength.

In one aspect of the invention, a single-pass fiber-laser based light source, as discussed, herein, is incorporated to a Raman imaging microscope.

In one aspect of the invention, the fiber-based gain medium may comprise a Erbium doped material that may provide amplification of a known wavelength generated by the light source.

In one aspect the invention, the single-pass fiber amplifier architecture presented discloses satisfies the need for a portable and/or transportable laser system required for many emerging atomic cooling applications.

### BRIEF DESCRIPTION OF DRAWINGS

For a better understanding of exemplary embodiments and to show how the same may be carried into effect, reference is made to the accompanying drawings. It is stressed that the particulars shown are by way of example only and for purposes of illustrative discussion of the preferred embodiments of the present disclosure and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 illustrates a block diagram of an exemplary embodiment of a single-stage fiber-based amplifier in accordance with the principles of the invention.

FIG. 2 illustrates a block diagram of an exemplary embodiment of a dual-stage fiber-based amplifier in accordance with the principles of the invention.

### DETAILED DESCRIPTION

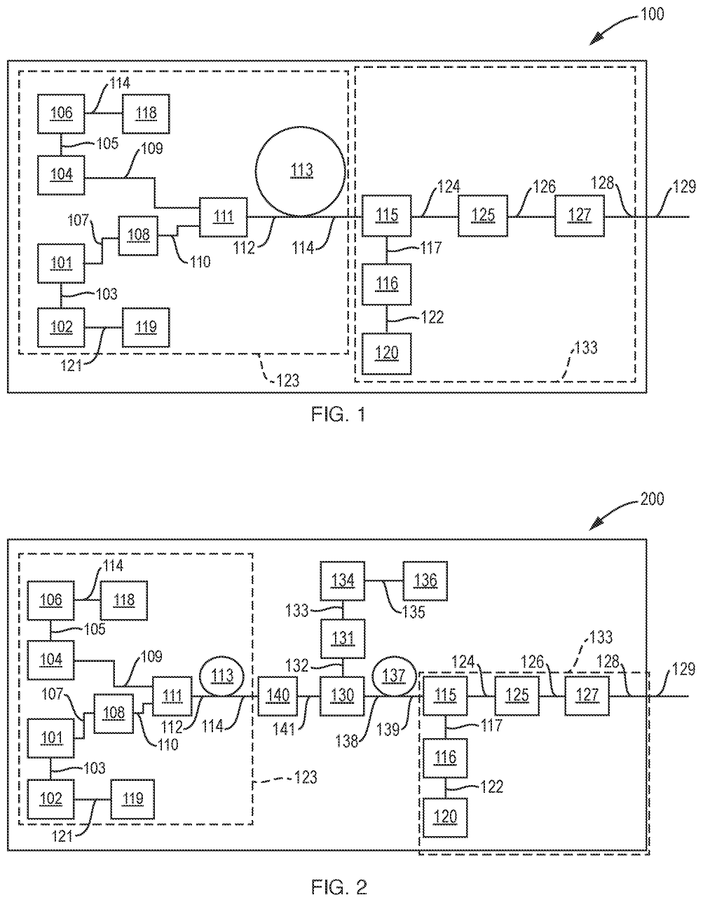

FIG. 1 illustrates a block diagram of an exemplary embodiment of a single-stage fiber-based amplifier 100 in accordance with the principles of the invention.

In this exemplary embodiment, fiber-based amplifier 100 comprises a gain stage 123 and a frequency multiplication stage 133, wherein the amplified wavelength output of gain stage 123 is provided through fiber connection 114 to frequency multiplication stage 133 for subsequent outputting on fiber connection 128/129.

In accordance with the principle of the invention, gain stage 123 comprises a semiconductor seed laser 101, preferrable a single-spatial-mode laser, configured to emit a seed laser wavelength along fiber 107, wherein fiber 107 is preferably a single-mode polarization maintaining (PM) fiber.

Seed laser 101 is electrically connected, by wire connection 103, to, and controlled by, a laser driver/thermoelectric temperature controller 102, which is electrically powered, through wire connection 121. In one aspect of the invention, electrical power is provided by a conventional AC-DC power supply 119. Alternatively, electrical power may be provided through a constant power source (e.g., battery) that may be rechargeable.

Seed laser 101 may comprise one of a distributed feedback (DFB) laser, a distributed Bragg Reflector (DBR) laser, or a wavelength-stabilized Fabry-Perot (FP) laser. The optical output power of the seed laser 101 may be in a range of 5 milliwatts (mW) to 100 mW based on the drive current of driver 102.

Further illustrated is semiconductor pump laser 104, preferably having a multi-spatial mode output, with a multimode fiber output fiber 109. Pump laser 104, is electrically connected through connection 105 to, and controlled by, laser driver/thermoelectric temperature controller 106, which is electrically powered, through connection 114, by the illustrated AC-DC power supply 118. In one aspect of the invention AC-DC power supply 118 and 119 may be a same device comprising outputs that may separately power seed laser 101 and pump laser 104.

Semiconductor pump laser 104 may be realized with individual or multiple semiconductor lasers that are fiber coupled into a single multimode output fiber 109. In addition, semiconductor pump laser 104 may be realized with one or more free-running FP lasers or wavelength-stabilized FP lasers with VBGs.

In one aspect of the invention, pump laser 104 may be realized with active cooling with a thermoelectric cooler, as shown, or passive convective cooling with a heat sink and a fan (not shown).

The output of pump laser 104 may be in a range of 5 watts (W) to 100 W based on the drive current and voltage provided by driver 106.

In accordance with the principles of the invention, the optical output of the seed laser 101 is optically coupled through fiber 107 to an optical polarization maintaining (PM) isolator 108. Optical PM isolator 108, which may be an internal free-space PM isolator within seed laser 101 or may be an external fiber-based PM isolator, prevents optical back reflections from the remaining optical amplifier circuit.

In this illustrate aspect of the invention, the single-spatial-mode output of PM isolator 108 is coupled, through fiber 110, to a core element (not shown) of PM combiner 111, while the output of the pump laser 104 is coupled, through fiber 109, to an inner clad element (not shown) of PM combiner 111.

In accordance with the principles of the invention, the passive double-clad PM optical fiber 112 extending from the output of the PM combiner 111 is coupled to a known length of active gain fiber 113, which amplifies the seed wavelength within the core element of optical fiber 112. Active gain fiber 113 comprises multiple regions extending along a length of fiber 113, wherein fiber 113 comprises a first or core region, a second inner clad region that surrounds the first or core region, and a third outer clad region that surrounds the second or inner clad region. The first region is doped with an element selected from the Lanthanide series of elements (atomic numbers 57-71). In one aspect of the invention, fiber 113 may be doped with one or more of Holmium (Ho), Erbium (Er), Thulium (Tm) and Ytterbium (Yb), where the selection of the doping of fiber 113 is based, in part, on the seed and pump laser wavelengths. As would be understood in the art, the index of refraction of each region is selected to allow for the guiding of the seed laser wavelength within the first or core region of fiber 113 and the guiding of the pump laser wavelength within the second or inner clad region of the gain fiber 113.

Additionally, within optical gain fiber 113, the wavelength of pump laser 104 is absorbed within the first region of fiber 113 and amplifies the wavelength of seed laser 101 within the first or core region from the inputted milliwatt (mW) range to an outputted watt to tens-of-watt range.

The output of the active gain fiber 113 is fiber coupled 114 to wavelength determination section 133 comprising a non-linear crystal 115 for single-pass frequency multiplication (wavelength sub-multiplication) to a required output wavelength.

In one aspect of the invention, a temperature of the frequency multiplier crystal 115 is maintained by heater (not shown) that is controlled from external temperature controller 116, which is electrically powered, through electrical connection 122, by AC-DC power supply 120. In one aspect of the invention, frequency multiplication crystal 115 may represent a periodically poled lithium niobate (PPLN) crystal designed for second harmonic generation of the input wavelength. Although a second harmonic generation is discussed, it would be recognized that other modes of frequency multiplication may be utilized without altering the scope of the invention claimed.

The output of the frequency multiplication crystal 115 is coupled to fiber 124, which is optionally connected to an optical isolator 125 to prevent back reflections from the output fiber 128/129. The output of the optical isolator 125 is subsequently optionally coupled, through fiber 126, to dichroic mirror 127 for further suppression of the amplified undesired light. Finally, the output of dichroic beam splitter 127 may be connected to output fiber 128/129 for connection to an external system. For example, a microscope where the amplified laser output may be used as the illumination source. In this configuration, the reflected Raman scattered light from a sample under investigation can be collected by a suitable spectrometer. The high power of the illumination light source allows for rapid two-dimensional scanning of the excitation source across a sample and a two dimensional image of selected Raman scattered peaks can be created allowing the user to create a two-dimensional image of the chemical composition of their sample.

The overall control and setpoints of the complete system 100 may be maintained by an external microprocessor and control software (not shown). This may be accomplished with a master external controller or by individual microcontrollers for each of the illustrated driver/thermocouples 102, 106, and 116.

FIG. 2 illustrates a block diagram of an exemplary embodiment of a dual-stage fiber-based amplifier in accordance with the principles of the invention.

In this exemplary embodiment, the first-stage amplifier components 123 and frequency-multiplication components 133 are identical to those shown in FIG. 1 and, thus, a fuller descriptions of these elements may be had from the previous discussion regarding FIG. 1.

In accordance with the principles of the invention, the polarization maintaining output of the first-stage amplifier 123 on fiber 114 is coupled into a polarization maintaining (PM) optical isolator 140 to prevent back-reflections into the first-stage amplifier. It is noted that the PM optical isolator 140 may be an external free-space PM isolator or an external fiber-based PM isolator. In this exemplary example, the single-spatial-mode PM output on fiber 141 of PM isolator 140 is coupled to a core element of a second-stage PM combiner 130. In addition, the output of a second-stage pump laser 131 is coupled, through fiber 132, to an inner clad of second-stage PM combiner 130.

In a manner similar to the gain stage amplifier 123, a multi-spatial mode semiconductor pump laser(s) 131, which have multimode fiber output fiber(s) 132 that are electrically connected 133 to, and controlled, by a laser driver and thermoelectric temperature controller 134. The laser driver/thermoelectric controller(s) 134 are electrically powered, through wired connection 135, by AC-DC power supply 136.

The output of the second stage PM combiner 130 is fiber coupled to a length of active gain fiber 137. In the second-stage optical gain fiber 137, the pump laser power is absorbed within the core of the gain fiber 137 and amplifies the output of the first stage amplifier from the watt range that is produced by the first stage amplification to a tens-of-watt range.

In accordance with the principles of the invention, the output of the second stage of amplification is coupled, through fiber 139 to multiplication section 133, which, as previously described multiples the received input signal to generate a desired wavelength output at a sub-multiple wavelength of the input seed laser wavelength.

In accordance with the principles of the invention, the semiconductor pump laser(s) 104 and/or 131 may be realized with individual or multiple semiconductor lasers that are fiber coupled into a single multimode output fiber 109/132, respectively. In addition, semiconductor pump lasers 104/131 may be realized with either free-running Fabry-Perot (FP) lasers or wavelength-stabilized FP lasers with Voltage Bragg Gratings (VBGs).

In accordance with the principles of the invention, heat sinking of the pump laser 104/131 may be realized with active cooling with a thermoelectric cooler or passive convective cooling with a heat sink and fan.

In accordance with the principles of the invention, a seed laser wavelength operating at 1570 nm with an output power of approximately 50 mW within a single-mode output PM fiber may be amplified by the single stage optical amplifier 100 disclosed in FIG. 1 by passing the seed wavelength 1570 nm through the core region of active gain fiber 113 comprising a length of 5 meters of Er/Yb-doped gain with a pump laser wavelength of 976 nm to achieve a output power of at least 1.5 W. In addition, with a frequency multiplication factor of 2, a wavelength output of 785 nm with an output power of at least 0.5 W may be achieved.

In summary, a single pass fiber based amplifier has been described that provides for the generation and amplification of a laser wavelength suitable for Raman Spectral analysis, where the amplification is performed in an active gain fiber selected to amplify a seed laser wavelength using a pump laser at a different wavelength and generating a desired wavelength by frequency multiplication of the amplified seed wavelength.

Although the invention disclosed herein discusses specific wavelengths that are produced with currently available laser diodes, it would be recognized that the specific wavelengths as being absorbed and/or reflected may be changed and/or added to without altering the scope of the invention. In addition, it would be known in the art that the specific wavelengths discussed, herein, represent a band of wavelengths centered on the wavelength values presented herein to account for divergence of the wavelength generated by the lighting devices during the generation of the light and/or the operation of the lighting, wherein the light generated is represented as a nominal value.

Although the invention has been described with regard to a fiber connection to convey light between the illustrated elements associated with the illustrated embodiments, it would be recognized that the optical connection between the illustrated elements may be one of a free space optical connection.

The invention has been described with reference to specific embodiments. One of ordinary skill in the art, however, appreciates that various modifications and changes can be made without departing from the scope of the invention as set forth in the claims. Accordingly, the specification is to be regarded in an illustrative manner, rather than with a restrictive view, and all such modifications are intended to be included within the scope of the invention.

Benefits, other advantages, and solutions to problems have been described above with regard to specific embodiments. The benefits, advantages, and solutions to problems, and any element(s) that may cause any benefits, advantages, or solutions to occur or become more pronounced, are not to be construed as a critical, required, or an essential feature or element of any or all of the claims.

What is claimed is:

1. A single pass optical amplifier comprising:
a seed laser configured to:
emit, at a known power level, a light at a seed wavelength;
a pump laser configured to:
emit, at a second known power level, a light at a pump laser wavelength;
a gain fiber configured to:
receive said light at said seed wavelength and said light at said pump laser wavelength, wherein said light at said seed wavelength is inputted within a first region of said gain fiber and said light at said pump laser wavelength is inputted into a second region, wherein said second region is concentric to said first region; and
amplify said known power of said seed wavelength by excitation of material within said first region by said second known power level of said pump laser wavelength;
a frequency multiplier configured to:
receive amplified power level of said seed wavelength;
multiple a frequency of said seed wavelength by a known multiplication factor; and
output a known sub-multiple of said seed wavelength based on said known multiplication factor.

2. The single pass optical amplifier of claim 1, comprising:
a seed laser driver configured to:
drive said seed laser; and
a pump laser driver configured to:
drive said pump laser.

3. The single pass optical amplifier of claim 2, comprising:
a temperature controller associated with at least one of said seed laser drive and said pump laser driver, wherein said temperature controller is configured to:
maintain said seed laser at a known temperature; and
a power supply configured to:
provide a power to said seed laser driver and pump laser driver.

4. The single pass optical amplifier of claim 2, comprising:
an optical isolator configured to:
provide optically isolation between said seed laser and said gain fiber.

5. The single pass amplifier of claim 1, wherein said gain fiber is selected based on said seed laser wavelength.

6. The single pass optical amplifier of claim 5, wherein said second region comprises at least one Lanthanide based element.

7. The single pass optical amplifier of claim 6, wherein said Lanthanide based element is one of: Holmium (Ho), Erbium (Er), Thulium (Tm) and Ytterbium (Yb).

8. The single pass optical amplifier of claim 1, wherein said known multiplication of said frequency multiplier is selected based on said seed laser wavelength.

9. The single pass optical amplifier of claim 1, comprising:
a polarization maintaining fiber combiner configured to:
couple said seed wavelength and said pump laser wavelength into said gain fiber, wherein said gain fiber comprises a passive double-clad polarization maintaining fiber.

10. The single pass optical amplifier of claim 1, comprising:
an optical isolator configured to:
optically isolate said outputted sub-multiple of said seed wavelength.

11. The single pass optical amplifier of claim 1, wherein said amplification of said seed wavelength is based on at least one of: a length of said gain fiber, said known power of said seed wavelength and a known power of said pump laser wavelength.

12. The single pass optical amplifier of claim 5, wherein said Lanthanide based element within said gain fiber is selected based on said pump laser wavelength.

13. A dual stage optical amplifier comprising:
a first single pass optical amplifer comprising
a first pump laser configured to:
emit a light at a first pump laser wavelength;
a first seed laser configured to:
emit a light at a seed laser wavelength; and
a first gain stage optical combiner configured to:
receive said light associated with said first pump laser wavelength and said light associated with said seed laser wavelength; and
a fiber gain element configured to:
receive said light associated with seed laser wavelength within a core element of said fiber gain element; and
receive said light associated with said first pump laser wavelength within a region surrounding said core element; and
output an amplified light associated with said seed laser wavelength;
a second single pass optical amplifier comprising:
a second pump laser configured to:
emit a second light at said first pump laser wavelength; and
a second gain stage optical combiner configured to:
receive said second light associated with said first pump laser wavelength and said amplified light associated with said seed laser wavelength; and
a second fiber gain element configured to:
receive said amplified light associated with seed laser wavelength within a core element of said second fiber gain element; and
receive said second light associated with said first pump laser wavelength within a region surrounding said core element of said second fiber gain element; and
output a further amplified light associated with said seed laser wavelength; and
a multiplier section configured to:
receive said further amplified light associated with said seed laser wavelength;
multiple a frequency of said further amplified light by a known multiplication factor; and
output said further amplified light at a wavelength a known sub-multiple of said seed laser wavelength.

14. The dual stage optical amplifier of claim 13, wherein said known multiplication factor is at least two (2).

15. The dual stage optical amplifier of claim 13, wherein amplification by said first single pass optical amplifier of said light associated with said seed laser is based on at least one of: a drive current applied to said first seed laser, a drive current applied to said first pump laser and a length of said first gain fiber.

16. The dual stage optical amplifier of claim 15, wherein amplification by said second stage optical amplifier of said amplified light associated with said seed laser is based on at least one of: a drive current applied to said second pump laser and a length of said second gain fiber.

17. The dual stage optical amplifier of claim 13 wherein said first gain fiber and said second gain fiber are doped with at least one Lanthanide based element.
